(19) United States
(12) Patent Application Publication
(10) Pub. No.: US 2022/0390305 A1
(43) Pub. Date: Dec. 8, 2022

(54) FORCE DETECTOR

(71) Applicant: Honda Motor Co., Ltd., Tokyo (JP)

(72) Inventors: Ryusuke ISHIZAKI, Saitama (JP); Fumiya HAMATSU, Saitama (JP); Kazuyuki TAKAHASHI, Saitama (JP); Tomoyuki SAKURAI, Saitama (JP)

(73) Assignee: Honda Motor Co., Ltd., Tokyo (JP)

(21) Appl. No.: 17/715,019

(22) Filed: Apr. 6, 2022

(30) Foreign Application Priority Data
Jun. 8, 2021 (JP) 2021-096080

(51) Int. Cl. G01L 5/162

(52) U.S. Cl. CPC G01L 5/162

(57) ABSTRACT

A force detector includes a low load cell, a high load cell, a first presser and a second presser. The first presser and the second presser have pressing surfaces having different areas from each other. When the same force acts on the first presser and the second presser, the low load cell and the high load cell are configured so that their outputs indicate different values from each other.

### CROSS-REFERENCE TO RELATED APPLICATIONS

This application claims the priority benefit of Japan Application No. 2021-096080, filed on Jun. 8, 2021. The entirety of the above-mentioned patent application is hereby incorporated by reference herein and made a part of this specification.

### BACKGROUND

### Technical Field

The disclosure relates to a force detector that detects force by using the piezoresistive effect.

### Related Art

As a force detector, one described in Patent Document 1 has been conventionally known. This force detector includes multiple pressure sensors and a pressing member. The pressing member has multiple protrusions and these protrusions are disposed so as to face electrodes of the multiple pressure sensors.

In this force detector, when a force acts on the pressing member, since the protrusions of the pressing member press the electrode of each pressure sensor, a change occurs in electrical resistance of the electrode. Accordingly, a force acting on each pressure sensor is detected based on the change in electrical resistance in the pressure sensor. That is, the force is detected by using the piezoresistive effect in the pressure sensor.

[Patent Document 1] WO 2007/074891

Recently, it has been desired to widen a force detectable range of the force detector from the viewpoint of improving versatility, and the same is desired in the conventional force detector.

### SUMMARY

One embodiment provides a force detector that detects force by using a piezoresistive effect. The force detector includes: a first pressure sensor, having a piezoresistive effect; a first pressing part, disposed so as to face the first pressure sensor, and having a first pressing surface for pressing the first pressure sensor; a second pressure sensor, disposed adjacent to the first pressure sensor and having a piezoresistive effect; and a second pressing part, disposed so as to face the second pressure sensor, and having a second pressing surface for pressing the second pressure sensor. An output of the first pressure sensor and an output of the second pressure sensor are configured to indicate different values from each other when a same force acts on the first pressing part and the second pressing part.

### BRIEF DESCRIPTION OF THE DRAWINGS

FIG. 1 is a front view schematically illustrating a configuration of a force detector according to an embodiment of the disclosure.

FIG. 2 illustrates a configuration of a pressing member as viewed in a direction I-I of FIG. 1.

FIG. 3 is a plan view illustrating a configuration of a pressure sensor.

FIG. 4 is a plan view illustrating a positional relationship between a first pressing surface and a second pressing surface, and a low load cell and a high load cell of a pressure sensor.

FIG. 5 illustrates a characteristic curve of force versus electrical resistance in a force detector.

FIG. 6 illustrates a relationship between a pressure detection range required for a force detector and a specification detection range of a pressure sensor.

FIG. 7 is an explanatory diagram of a method for determining the area of a first pressing surface.

FIG. 8 is an explanatory diagram of a method for determining the area of a second pressing surface.

FIG. 9 illustrates a formula for calculating force by a force detector, and the like.

FIG. 10 illustrates regions in which values of a low load cell and a high load cell are used in a force detector.

FIG. 11 is for describing a center of pressure.

FIG. 12 illustrates a calculation result of a center of pressure in the case of using only a low load cell.

FIG. 13 illustrates a calculation result of a center of pressure in the case of using only a high load cell.

FIG. 14 illustrates a calculation result of a center of pressure in the case of using a low load cell and a high load cell.

FIG. 15 is for describing a force detection method to which an image interpolation method is applied.

FIG. 16 is for describing another force detection method to which an image interpolation method is applied.

### DESCRIPTION OF THE EMBODIMENTS

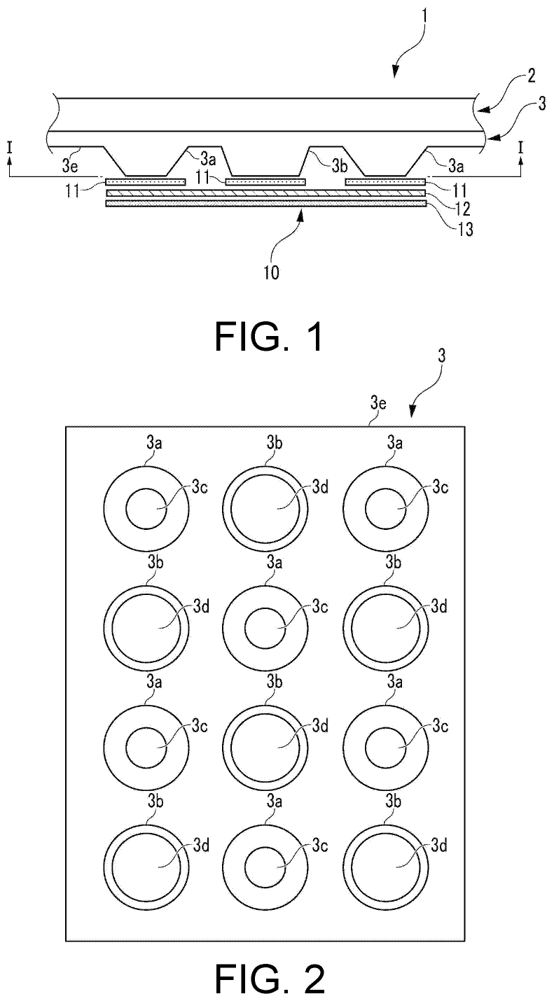

A force detector 1 according to an embodiment of the disclosure is described below with reference to FIG. 1 to FIG. 4. In the following description, for convenience, an up-down direction, a left-right direction, the near side, and the far side in FIG. 1 are referred to as “up and down”, “left and right”, “front”, and “rear”, respectively.

As illustrated in FIG. 1, the force detector 1 of the present embodiment includes a surface layer member 2, a pressing member 3, and a pressure sensor 10 in this order from up to down. The surface layer member 2 is a member having a thin plate shape, and includes a flexible material (for example, urethane, silicon, or chloroprene rubber).

The surface layer member 2 is for mitigating an impact due to contact with an object or for ensuring a frictional force with an object. If these functions are not required in the force detector 1, the surface layer member 2 may be omitted.

The pressing member 3 is a member that presses the pressure sensor 10 by a force when the force acts on the surface layer member 2, and the pressing member 3 includes a material (for example, acrylic or silicon) having a predetermined hardness.

As illustrated in FIG. 2, the pressing member 3 includes a base 3e, a large number (only six are illustrated) of first pressers 3a, and a large number (only six are illustrated) of second pressers 3b. Since the first pressers 3a and the second pressers 3b are integrally configured, they have the same physical properties. In the present embodiment, the first presser 3a corresponds to one of a first pressing part and a second pressing part, and the second presser 3b corresponds to the other of the first pressing part and the second pressing part. The base 3e is formed in a thin plate shape, and is disposed in contact with a lower surface of the surface layer member 2.

When the pressing member 3 is viewed in plan view, the first presser 3a and the second presser 3b are alternately arranged side by side in the left-right direction and the front-rear direction, and centers thereof are disposed so as to be at equal intervals. That is, the first presser 3a and the second presser 3b are disposed in a lattice pattern in plan view.

The first presser 3a is formed integrally with the base 3e and protrudes downward from the base 3e at a predetermined height. The first presser 3a has a truncated cone shape, and a top surface thereof is a pressing surface 3c having a circular shape. The pressing surface 3c abuts the pressure sensor 10 and presses the pressure sensor 10 when the pressing member 3 is pushed downward, and the pressing surface 3c has a predetermined first area Sa. In the present embodiment, the pressing surface 3c corresponds to one of a first pressing surface and a second pressing surface.

Similarly to the first presser 3a, the second presser 3b is formed integrally with the base 3e and protrudes downward from the base 3e at the same height as the first presser 3a. The second presser 3b has a truncated cone shape, and a top surface thereof is a pressing surface 3d having a circular shape. The pressing surface 3d abuts the pressure sensor 10 when the pressing member 3 is pushed downward, and the pressing surface 3d has a predetermined second area Sb. In the present embodiment, the pressing surface 3d corresponds to the other of the first pressing surface and the second pressing surface.

The first area Sa and the second area Sb satisfy a relationship of Sa<Sb, and are set so that the characteristics described later can be obtained in outputs of a low load cell 10A and a high load cell 10B of the pressure sensor 10 that are described later.

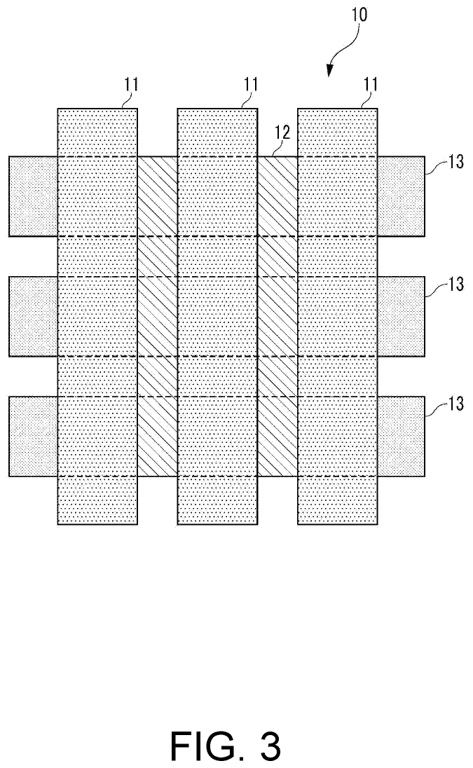

Next, the pressure sensor 10 is described. The pressure sensor 10 detects pressure by using the piezoresistive effect, and includes a large number (only three are illustrated) of upper electrodes 11, a pressure-sensitive material 12, and a large number (only three are illustrated) of lower electrodes 13 in this order from up to down, as illustrated in FIG. 1 and FIG. 3.

The large number of upper electrodes 11 extend in the front-rear direction, and are disposed side by side in the left-right direction at predetermined intervals from each other. Each upper electrode 11 has a predetermined width in the left-right direction and a predetermined thickness in the up-down direction, and is formed in the shape of an elongated thin plate rectangular in plan view. Each upper electrode 11 is connected to an electric circuit device (not illustrated) via an electric wire (not illustrated).

The large number of lower electrodes 13 extend in the left-right direction, and are disposed side by side in the front-rear direction at predetermined intervals from each other. The interval between adjacent lower electrodes 13 and 13 is set to be the same as the interval between adjacent upper electrodes 11 and 11.

Further, the lower electrode 13 is formed in the shape of an elongated thin plate rectangular in a plan view. The width of the lower electrode 13 in the front-rear direction is the same as the width of the upper electrode 11 in the left-right direction, and the thickness of the lower electrode 13 in the up-down direction is the same as the thickness of the upper electrode 11 in the up-down direction. The lower electrode 13 and the upper electrode 11 may be configured so as to have different widths in the left-right direction and different thicknesses in the up-down direction. Each lower electrode 13 is connected to an electric circuit device (not illustrated) via an electric wire (not illustrated).

The pressure-sensitive material 12 is a member having a thin plate shape, and is disposed between the upper electrode 11 and the lower electrode 13. The pressure-sensitive material 12 includes a material (for example, synthetic rubber, or elastomer) having dielectric properties and elasticity, and contains a large number of conductive particles therein.

In the pressure sensor 10 configured as above, when the upper electrode 11 is pressed from above, as the pressure-sensitive material 12 is elastically deformed and a distance between the conductive particles in the pressure-sensitive material 12 is reduced, electrical resistance in the pressure-sensitive material 12 is reduced. As a result, in the electric circuit device, based on a change in electrical resistance between the upper electrode 11 and the lower electrode 13 in the pressure sensor 10, a force (load) acting on the pressure sensor 10 becomes detectable. That is, the pressure sensor 10 has a piezoresistive effect.

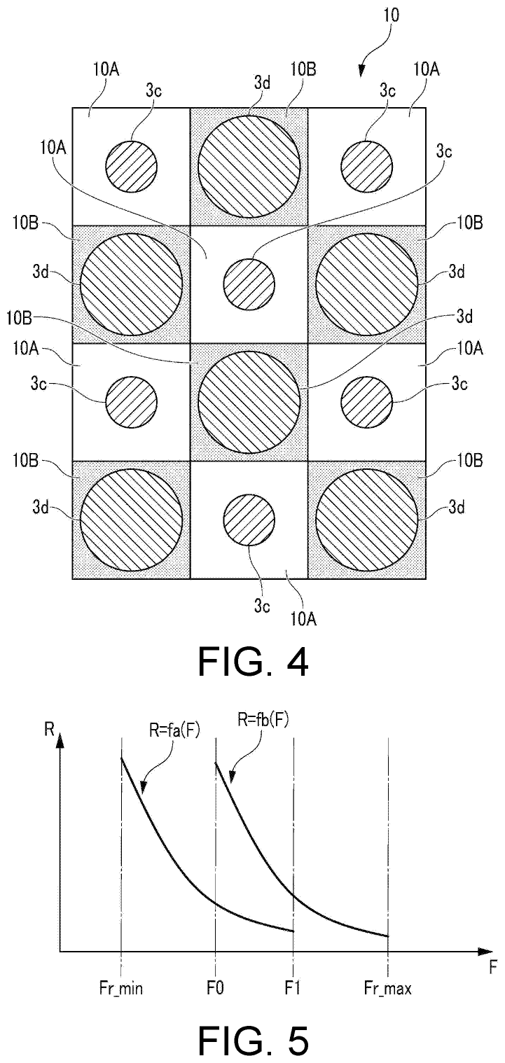

In the case of the force detector 1 of the present embodiment, as described above, the pressing member 3 includes two types of pressers, namely, the first presser 3a and the second presser 3b. When a force acts on the pressing member 3, the pressing surface 3c of the first presser 3a and the pressing surface 3d of the second presser 3b abut the pressure sensor 10 in a state illustrated in FIG. 4.

In FIG. 4, the low load cell 10A conveniently represents a region of the upper electrode 11 abutted by the pressing surface 3c of the first presser 3a, and the high load cell 10B conveniently represents a region of the upper electrode 11 abutted by the pressing surface 3d of the second presser 3b. In FIG. 4, the pressing surface 3c and the pressing surface 3d are represented by hatching to facilitate understanding.

In the case of the force detector 1 of the present embodiment, a relationship between force F acting on the first presser 3a and electrical resistance R of the low load cell 10A is configured to obtain a characteristic curve fa(F) illustrated in FIG. 5.

A relationship between the force F acting on the second presser 3b and the electrical resistance R of the high load cell 10B is configured to obtain a characteristic curve fb(F) illustrated in FIG. 5. In the present embodiment, the low load cell 10A corresponds to one of a first pressure sensor and a second pressure sensor, and the high load cell 10B corresponds to the other of the first pressure sensor and the second pressure sensor.

In FIG. 5, Fr_min and Fr_max respectively represent a minimum value and a maximum value of the force F detectable by the force detector 1. F0 and F1 are predetermined values of the force F set so as to satisfy Fr_min<F0<F1<Fr_max.

As is clear from the characteristic curve fa(F), in the case of a combination of the first presser 3a and the low load cell 10A, a detectable range of the force F acting on the first presser 3a is set to a range from the minimum value Fr_min to the predetermined value F1. In the case of a combination of the second presser 3b and the high load cell 10B, a detectable range of the force F acting on the second presser 3b is set to a range from the predetermined value F0 to the maximum value Fr_max.

That is, in the force detector 1 of the present embodiment, the detectable range of the force F acting on the first presser 3a and the detectable range of the force F acting on the second presser 3b are configured to overlap between the predetermined value F0 and the predetermined value F1. A reason why the force detector 1 is configured in this way is described below.

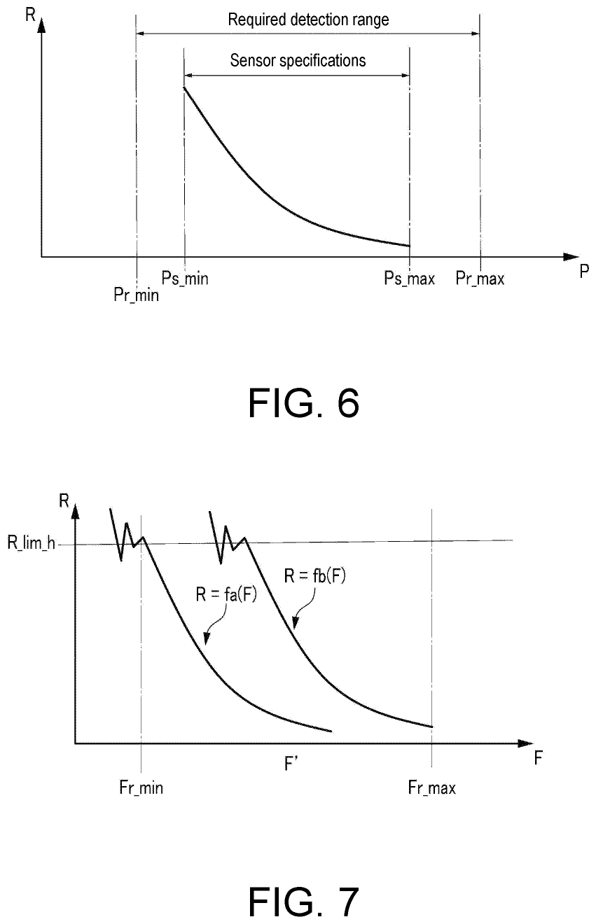

Firstly, in the case where a force detection range required for the force detector 1 is a range from the minimum value Fr_min to the maximum value Fr_max described above, when this range is replaced with a pressure range, a range from a minimum value Pr_min to a maximum value Pr_max is obtained, as illustrated in FIG. 6. The minimum value Pr_min is a value that satisfies Pr_min=Fr_min/Se in the case where the area of the low load cell 10A (=the area of the high load cell 10B) is Se, and the maximum value Pr_max is a value that satisfies Pr_max=Fr_max/Se.

As illustrated in FIG. 6, in the case where a pressure detection range in specifications of the pressure sensor 10 is a range from a minimum value Ps_min (>Pr_min) to a maximum value Ps_max (<Pr_max), since the range from Ps_min to Ps_max is narrower than the above range from Pr_min to Pr_max, it is not possible to cover the entire pressure detection range by the pressure sensor 10.

Hence, by configuring the first area Sa, which is the area of the pressing surface 3c of the first presser 3a, so that Sa·Ps_min=Fr_min is satisfied, by the first presser 3a and the low load cell 10A, the force F in the range from the minimum value Fr_min to the predetermined value F1 (=Ps_max·Sa) can be detected. As a result, the relationship between the force F acting on the first presser 3a and the value of the electrical resistance R of the low load cell 10A is as illustrated by the characteristic curve fa(F) in FIG. 5.

By configuring the second area Sb, which is the area of the pressing surface 3d of the second presser 3b, so that Sb·Ps_max=Fr_max is satisfied, by the second presser 3b and the high load cell 10B, the force F in the range from the predetermined value F0 (=Ps_min·Sb) to the maximum value Fr_max can be detected. As a result, the relationship between the force F acting on the second presser 3b and the value of the electrical resistance R of the high load cell 10B is as illustrated by the characteristic curve fb(F) in FIG. 5.

In addition, the specifications of the pressure sensor 10, the first area Sa, and the second area Sb are determined so as to satisfy the following three conditions (a1) to (a3). All these conditions (a1) to (a3) are for improving detection accuracy of the force detector 1 for the force F.

(a1) The specifications of the pressure sensor 10, the first area Sa and the second area Sb are determined so that a region in which the two characteristic curves fa(F) and fb(F) in FIG. 5 overlap is as large as possible.

(a2) The first area Sa of the pressing surface 3c of the first presser 3a and the specifications of the pressure sensor 10 are determined so that, when the force F of the minimum value Fr_min acts on the first presser 3a, an output (electrical resistance R) of the low load cell 10A reaches an upper limit R_lim_h. As illustrated in FIG. 7, the upper limit R_lim_h corresponds to a value at which the output of the low load cell 10A stabilizes.

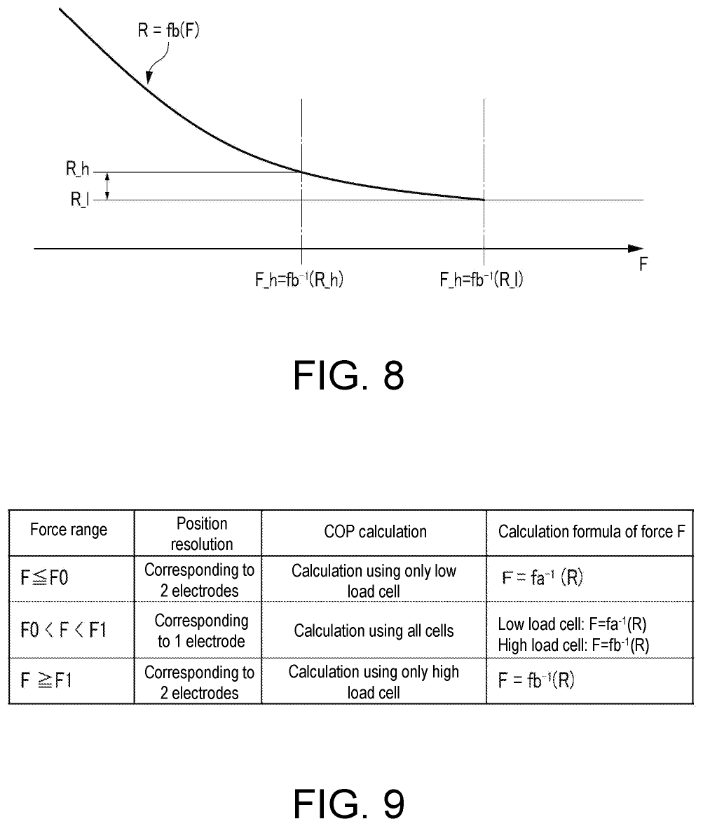

(a3) In the case where a resolution of the force F required by the force detector 1 is ΔF_req and a resistance value required to change an AD conversion value by 1 least significant bit (LSB) is ΔR, in the characteristic curve fb(F) illustrated in FIG. 8, a minimum value of a resistance value R_l satisfying the conditions of R_h−R_l>ΔR and F_l−F_h<ΔF_req is selected. Then, the second area Sb is determined so that the value F_l(=Fb⁻¹(R_l))=Fr_max is satisfied.

In the force detector 1 configured as above, the force F acting on the force detector 1 is calculated (detected) as illustrated in FIG. 9 according to the range of the force F. As illustrated in FIG. 9, if the force F has a value within a range of F<F0, the force F is calculated by applying the value of the electrical resistance R of the low load cell 10A to the characteristic curve fa(F) described above. That is, the force F is calculated by a calculation formula of F=fa⁻¹(R).

In this case, a position resolution of the force detector 1 corresponds to a distance between two adjacent low load cells 10A and 10A, and corresponds to two electrodes. The center of pressure COP is calculated using only the value of the low load cell 10A.

If the force F acting on the force detector 1 has a value within a range of F1<F, the force F is calculated by applying the value of the electrical resistance R of the high load cell 10B to the characteristic curve fb(F) described above. That is, the force F is calculated by a calculation formula of F=fb⁻¹(R).

In this case, the position resolution of the force detector 1 corresponds to a distance between two adjacent high load cells 10B and 10B, and corresponds to two electrodes. The center of pressure COP is calculated using only the value of the high load cell 10B.

If the force F acting on the force detector 1 has a value within a range of F0≤F≤F1, the force F is calculated using the outputs of the low load cell 10A and the high load cell 10B.

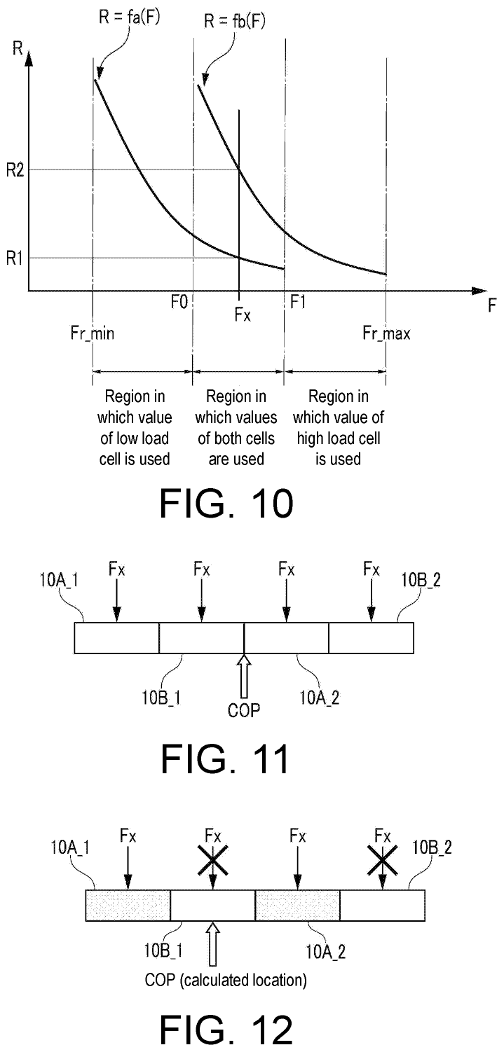

For example, as illustrated in FIG. 10, in the case where a force Fx (F0≤Fx≤F1) acts on the force detector 1, when the electrical resistance R of the low load cell 10A has a value R1, the force Fx is calculated by a calculation formula of Fx=Fa⁻¹(R1). At the same time, when the electrical resistance R of the high load cell 10B has a value R2, the force Fx is calculated by a calculation formula of Fx=Fb⁻¹(R2).

Further, the position resolution of the force detector 1 corresponds to a distance between the low load cell 10A and the high load cell 10B adjacent to each other, and corresponds to one electrode. The center of pressure COP is calculated using the values of the low load cell 10A and the high load cell 10B.

In the case of using the values of the low load cell 10A and the high load cell 10B in this way, the following effects can be obtained. That is, as illustrated in FIG. 11, in the case where the force Fx (F0≤Fx≤F1), which is a distributed load, acts on low load cells 10A_1 and 10A_2 and high load cells 10B_1 and 10B_2 of the force detector 1, the actual center of pressure COP is between the high load cell 10B_1 and the low load cell 10A_2 that are adjacent to each other.

However, as illustrated in FIG. 12, if only the values of the electrical resistance R of the low load cells 10A_1 and 10A_2 are used, the calculated center of pressure COP may be located near the center of the high load cell 10B_1.

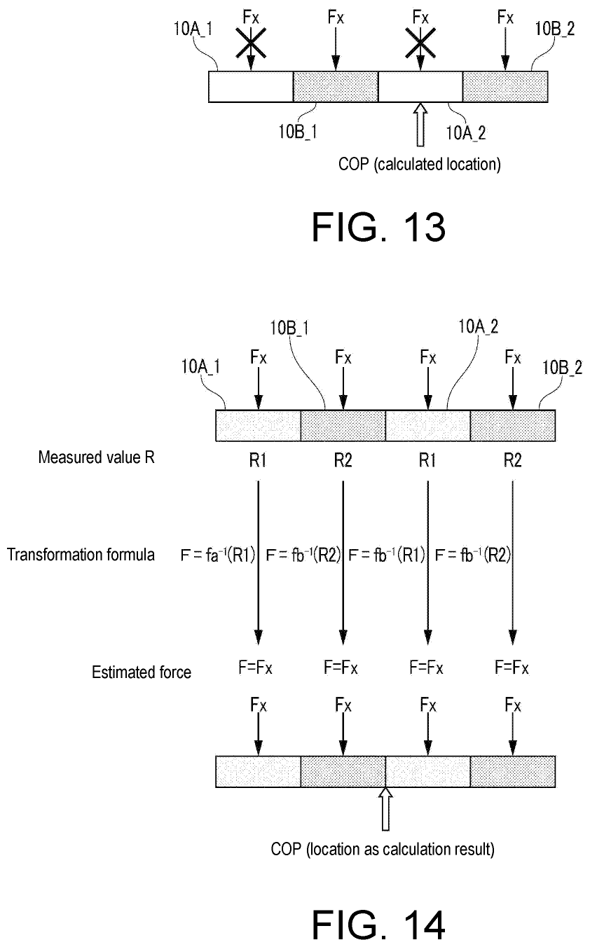

As illustrated in FIG. 13, if only the values of the electrical resistance R of the high load cells 10B_1 and 10B_2 are used, the calculated center of pressure COP may be located near the center of the low load cell 10A_2.

In contrast, as illustrated in FIG. 14, in the case of using the values of the electrical resistance R of both the low load cell 10A and the high load cell 10B, the center of pressure COP as a calculation result matches the actual center of pressure COP. That is, by using the values of the low load cell 10A and the high load cell 10B, calculation accuracy for the center of pressure COP can be improved.

As described above, according to the force detector 1 of the present embodiment, when the same force acts on the first presser 3a and second presser 3b, the electrical resistance R of the low load cell 10A and the high load cell 10B is configured to change as illustrated by the characteristic curves fa(F) and fb(F) in FIG. 5.

In this case, the characteristic curve fa(F) covers the range from the minimum value Fr_min to the predetermined value F1 of the force F, the characteristic curve fb(F) covers the range from the predetermined value F0 to the maximum value Fr_max of the force F, and these two characteristic curves overlap each other in the range from the predetermined value F0 to the predetermined value F1.

Accordingly, by the force detector 1, the force F within the required detection range from Fr_min to Fr_max can be detected continuously without a gap. That is, by setting the pressing surface 3c of the first presser 3a and the pressing surface 3d of the second presser 3b to have different areas, the force detectable range can be widened as compared with the case of using a single type of presser.

At that time, since the low load cell 10A and the high load cell 10B can be composed of one pressure sensor 10, and the first presser 3a and the second presser 3b can be composed of the same member, the cost can be reduced accordingly.

Since the outputs of both of the low load cell 10A and the high load cell 10B can be used in detecting the force F in the range from the predetermined value F0 to the predetermined value F1, when a distributed load in the range from the predetermined value F0 to the predetermined value F1 acts on the force detector 1, the resolution can be improved and the center of pressure COP can be detected with high accuracy as compared with the case of using a single type of pressure sensor.

In the case where the force F acting on the force detector 1 has a value within the range of F1<F, since only the high load cell 10B is used in detecting the force F, the resolution may be reduced as compared with the case of using both the low load cell 10A and the high load cell 10B. In order to compensate for this, an image interpolation method described below may be used.

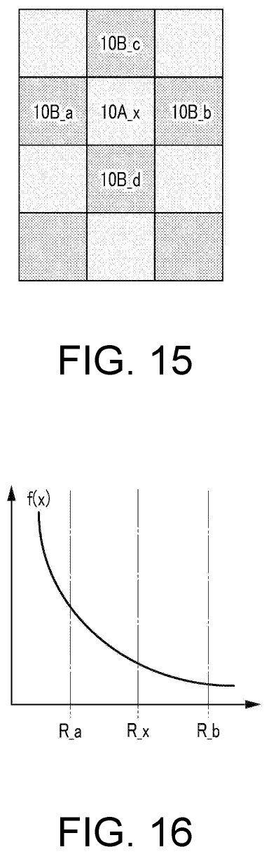

For example, as illustrated in FIG. 15, in the case of calculating a force F_x acting on a position of a low load cell 10A_x surrounded by four high load cells 10B_a to 10B_d, the force F_x is calculated by a linear interpolation method described below.

Firstly, electrical resistances R_a to R_d in the four high load cells 10B_a to 10B_d are captured as grayscale images. Then, a virtual electrical resistance R_x at the position of the low load cell 10A_x is calculated by the following equation (1). Ka to Kd in the following equation (1) are predetermined weighting factors.

R_x=Ka·R_a+Kb·R_b+Kc·R_c+Kd·R_d (1)

Then, by applying the electrical resistance R_x to the aforesaid characteristic curve fb(R), the force F_x is calculated. In the case where the above method is used, the force F_x acting on the position of the low load cell 10A_x can be detected, and accordingly, the resolution in the force detector 1 can be improved.

As illustrated in FIG. 16, for example, if it is known that the force F has a distribution in accordance with a function f(x), since a distance between the two high load cells 10B_a and 10B_b is also known, the electrical resistance R_x can be calculated by the following equation (2) (non-linear interpolation).

R_x=f(R_a+(R_b−R_a)/2) (2)

Then, by applying the electrical resistance R_x to the aforesaid characteristic curve fb(R), the force F_x is calculated. Also, in the case where the above method is used, the force F_x acting on the position of the low load cell 10A_x can be detected, and accordingly, the resolution in the force detector 1 can be improved.

Further, as the image interpolation method, it may be configured to calculate electrical resistance R_x by a learning method using an interpolation network and an identification network.

In an embodiment, an example has been given in which, by setting the areas of the pressing surfaces (3c and 3d) of two pressers (3a and 3b) as different values (Sa and Sb), the relationship between the electrical resistance R of two cells (10A and 10B) and the force F is configured as illustrated by the characteristic curves fa(F) and fb(F) illustrated in FIG. 5. However, the disclosure may alternatively be configured as follows.

For example, by setting the piezoresistive effects of the two cells (10A and 10B) to have the same characteristics, setting the areas of the pressing surfaces (3c and 3d) of the two pressers (3a and 3b) as different values, and configuring the two pressers (3a and 3b) to be different in one of elastic modulus and hardness, the relationship between the electrical resistance R of the two cells (10A and 10B) and the force F may be configured to be the same as the characteristic curves fa(F) and fb(F) illustrated in FIG. 5.

At that time, in the case where the area of the pressing surface 3c is greater than the area of the pressing surface 3d, the elastic modulus of the first presser 3a may be configured to have a greater value than the elastic modulus of the second presser 3b, or conversely, the elastic modulus of the first presser 3a may be configured to have a smaller value than the elastic modulus of the second presser 3b.

In the case where the area of the pressing surface 3c is smaller than the area of the pressing surface 3d, the elastic modulus of the first presser 3a may be configured to have a greater value than the elastic modulus of the second presser 3b, or conversely, the elastic modulus of the first presser 3a may be configured to have a smaller value than the elastic modulus of the second presser 3b.

Further, in the case where the area of the pressing surface 3c is greater than the area of the pressing surface 3d, the hardness of the first presser 3a may be configured to have a greater value than the hardness of the second presser 3b, or conversely, the hardness of the first presser 3a may be configured to have a smaller value than the hardness of the second presser 3b.

In addition, in the case where the area of the pressing surface 3c is smaller than the area of the pressing surface 3d, the hardness of the first presser 3a may be configured to have a greater value than the hardness of the second presser 3b, or conversely, the hardness of the first presser 3a may be configured to have a smaller value than the hardness of the second presser 3b.

On the other hand, by setting the areas of the pressing surfaces (3c and 3d) of the two pressers (3a and 3b) as different values, setting the two pressers (3a and 3b) to have the same physical properties, and configuring the two cells (10A and 10B) as different sensors having piezoresistive effects having different characteristics from each other, the relationship between the electrical resistance R of the two cells (10A and 10B) and the force F may be configured to be the same as the characteristic curves fa(F) and fb(F) illustrated in FIG. 5.

At that time, in the case where the area of the pressing surface 3c is greater than the area of the pressing surface 3d, the low load cell 10A may be configured to have greater electrical resistance R than the high load cell 10B for the same pressure, or conversely, the low load cell 10A may be configured to have smaller electrical resistance R than the high load cell 10B for the same pressure.

In the case where the area of the pressing surface 3c is smaller than the area of the pressing surface 3d, the low load cell 10A may be configured to have greater electrical resistance R than the high load cell 10B for the same pressure, or conversely, the low load cell 10A may be configured to have smaller electrical resistance R than the high load cell 10B for the same pressure.

On the other hand, by setting the areas of the pressing surfaces (3c and 3d) of the two pressers (3a and 3b) as the same, setting the two pressers (3a and 3b) to have the same physical properties, and configuring the two cells (10A and 10B) as different sensors having piezoresistive effects having different characteristics from each other, the relationship between the electrical resistance R of the two cells (10A and 10B) and the force F may be configured to be the same as the characteristic curves fa(F) and fb(F) illustrated in FIG. 5. At that time, the low load cell 10A may be configured to have greater electrical resistance R than the high load cell 10B for the same pressure.

Further, by setting the piezoresistive effects of the two cells (10A and 10B) to have the same characteristics, setting the areas of the pressing surfaces (3c and 3d) of the two pressers (3a and 3b) as the same, and configuring the two pressers (3a and 3b) to be different in one of elastic modulus and hardness, the relationship between the electrical resistance R of the two cells (10A and 10B) and the force F may be configured to be the same as the characteristic curves fa(F) and fb(F) illustrated in FIG. 5.

At that time, the two pressers (3a and 3b) may be configured so that the elastic modulus of the first presser 3a has a greater value than the elastic modulus of the second presser 3b, or that the hardness of the first presser 3a has a greater value than the hardness of the second presser 3b.

By setting the areas of the pressing surfaces (3c and 3d) of the two pressers (3a and 3b) as the same, setting the piezoresistive effects of the two cells (10A and 10B) to have different characteristics, and configuring the two pressers (3a and 3b) to be different in one of elastic modulus and hardness, the relationship between the electrical resistance R of the two cells (10A and 10B) and the force F may be configured to be the same as the characteristic curves fa(F) and fb(F) illustrated in FIG. 5.

For example, in the case where the pressing surfaces (3c and 3d) of the two pressers (3a and 3b) have the same area, and the low load cell 10A has greater electrical resistance R than the high load cell 10B for the same pressure, the elastic modulus of the first presser 3a may be configured to have a greater value than the elastic modulus of the second presser 3b, or conversely, the elastic modulus of the first presser 3a may be configured to have a smaller value than the elastic modulus of the second presser 3b.

In the case where the pressing surfaces (3c and 3d) of the two pressers (3a and 3b) have the same area, and the low load cell 10A has greater electrical resistance R than the high load cell 10B for the same pressure, the hardness of the first presser 3a may be configured to have a greater value than the hardness of the second presser 3b, or conversely, the hardness of the first presser 3a may be configured to have a smaller value than the hardness of the second presser 3b.

Further, in the case where the pressing surfaces (3c and 3d) of the two pressers (3a and 3b) have the same area, and the low load cell 10A has smaller electrical resistance R than the high load cell 10B for the same pressure, the elastic modulus of the first presser 3a may be configured to have a greater value than the elastic modulus of the second presser 3b, or conversely, the elastic modulus of the first presser 3a may be configured to have a smaller value than the elastic modulus of the second presser 3b.

In addition, in the case where the pressing surfaces (3c and 3d) of the two pressers (3a and 3b) have the same area, and the low load cell 10A has smaller electrical resistance R than the high load cell 10B for the same pressure, the hardness of the first presser 3a may be configured to have a greater value than the hardness of the second presser 3b, or conversely, the hardness of the first presser 3a may be configured to have a smaller value than the hardness of the second presser 3b.

Further, by setting the areas of the pressing surfaces (3c and 3d) of the two pressers (3a and 3b) as different values, setting the piezoresistive effects of the two cells (10A and 10B) to have different characteristics, and configuring the two pressers (3a and 3b) to be different in one of elastic modulus and hardness, the relationship between the electrical resistance R of the two cells (10A and 10B) and the force F may be configured to be the same as the characteristic curves fa(F) and fb(F) illustrated in FIG. 5.

In an embodiment, an example has been given in which the pressing surface 3c of the first presser 3a and the pressing surface 3d of the second presser 3b are configured in a circular shape in plan view. However, the pressing surfaces 3c and 3d may alternatively be configured in a polygonal shape in plan view, an elliptical shape in plan view, a semi-elliptical shape in plan view, or a semi-circular shape in plan view.

Further, in an embodiment, an example has been given in which the detectable ranges of the low load cell 10A and the high load cell 10B are configured to overlap in the range from F0 to F1 illustrated in FIG. 5. However, it may alternatively be configured that the maximum value of force detectable by the low load cell 10A and the minimum value of force detectable by the high load cell 10B are the same value.

In an embodiment, an example has been given in which the low load cell 10A and the high load cell 10B are alternately disposed at equal intervals in the left-right direction and the front-rear direction. However, the low load cell 10A and the high load cell 10B may alternatively be distributedly disposed so as to be alternately adjacent to each other. Further, multiple low load cells 10A may be disposed adjacent to each other, or high load cells 10B may be disposed adjacent to each other.

The disclosure provides a force detector capable of widening a force detectable range in the case of detecting force by using the piezoresistive effect.

One aspect of the disclosure is the force detector 1 which detects force by a change in the electrical resistance R. The force detector 1 includes: a first pressure sensor (the pressure sensor 10, one of the low load cell 10A and the high load cell 10B) of a pressure-sensitive type, changing in the electrical resistance R when pressed; a first pressing part (one of the first presser 3a and the second presser 3b), disposed so as to face the first pressure sensor and having a first pressing surface for pressing the first pressure sensor; a second pressure sensor (the pressure sensor 10, the other of the low load cell 10A and the high load cell 10B) of a pressure-sensitive type, disposed adjacent to the first pressure sensor, and changing in the electrical resistance R when pressed; and a second pressing part (the other of the first presser 3a and the second presser 3b), disposed to face the second pressure sensor and having a second pressing surface for pressing the second pressure sensor. An output of the first pressure sensor and an output of the second pressure sensor are configured to indicate different values from each other when the same force acts on the first pressing part and the second pressing part.

According to the force detector, the first pressure sensor and the second pressure sensor are configured so that their outputs indicate different values from each other when the same force acts on the first pressing part and the second pressing part. Thus, the range of force detectable by the first pressure sensor and the range of force detectable by the second pressure sensor are different. As a result, the force detectable range can be widened as compared with a conventional case of using multiple pressure sensors having the same force detectable range. Accordingly, the versatility and usefulness of the force detector can be improved.

In another aspect, in the force detector 1, due to that the first pressing surface (one of the pressing surfaces 3c and 3d) of the first pressing part and the second pressing surface (the other of the pressing surfaces 3c and 3d) of the second pressing part have different areas (Sa and Sb) from each other, the output of the first pressure sensor and the output of the second pressure sensor are configured to indicate different values from each other when the same force acts on the first pressing part and the second pressing part.

According to the force detector, by configuring the first pressing surface of the first pressing part and the second pressing surface of the second pressing part to have different areas from each other, a force detection range can be widened.

In another aspect, in the force detector 1, by configuring the first pressing part and the second pressing part to be different in one of elastic modulus and hardness, the output of the first pressure sensor and the output of the second pressure sensor are configured to indicate different values from each other when the same force acts on the first pressing part and the second pressing part.

According to the force detector, by configuring the first pressing part and the second pressing part to be different in one of elastic modulus and hardness, a force detection range can be widened.

In another aspect, in the force detector 1, due to that the first pressure sensor and the second pressure sensor have piezoresistive effects having different characteristics from each other, the output of the first pressure sensor and the output of the second pressure sensor are configured to indicate different values from each other when the same force acts on the first pressing part and the second pressing part.

According to the force detector, by configuring the first pressure sensor and the second pressure sensor to have piezoresistive effects having different characteristics from each other, a force detection range can be widened.

In another aspect, in the force detector 1, a force detectable range based on the output of the first pressure sensor is configured to overlap a force detectable range based on the output of the second pressure sensor.

According to the force detector, since the force detectable ranges based on the outputs of the two pressure sensors are configured to overlap, in a range from the higher upper limit of the upper limits of the two force detectable ranges to the lower lower limit of the lower limits of the two force detectable ranges, a force can be detected continuously without a gap. Accordingly, the versatility and usefulness of the force detector can further be improved.

In another aspect, the force detector 1 further includes multiple first pressure sensors, multiple first pressing parts, multiple second pressure sensors, and multiple second pressing parts.

According to the force detector, since multiple first pressure sensors, multiple first pressing parts, multiple second pressure sensors, and multiple second pressing parts are further included, the force detectable range can be widened in multiple positions.

In another aspect, in the force detector 1, each of the multiple first pressure sensors and each of the multiple second pressure sensors are distributedly disposed so as to be alternately adjacent to each other.

According to the force detector, since each of the multiple first pressure sensors and each of the multiple second pressure sensors are distributedly disposed so as to be alternately adjacent to each other, when a distributed load acts on the force detector, the resolution can be improved and the center of pressure COP can be detected with high accuracy as compared with the case of using a single type of pressure sensor.

What is claimed is:

1. A force detector, detecting force by using a piezoresistive effect, the force detector comprising:
a first pressure sensor, having a piezoresistive effect;
a first pressing part, disposed so as to face the first pressure sensor, and having a first pressing surface for pressing the first pressure sensor;
a second pressure sensor, disposed adjacent to the first pressure sensor and having a piezoresistive effect; and
a second pressing part, disposed so as to face the second pressure sensor, and having a second pressing surface for pressing the second pressure sensor,
wherein
an output of the first pressure sensor and an output of the second pressure sensor are configured to indicate different values from each other when a same force acts on the first pressing part and the second pressing part.

2. The force detector according to claim 1, wherein
due to that the first pressing surface of the first pressing part and the second pressing surface of the second pressing part have different areas from each other, the output of the first pressure sensor and the output of the second pressure sensor are configured to indicate different values from each other when the same force acts on the first pressing part and the second pressing part.

3. The force detector according to claim 1, wherein
due to that the first pressing part and the second pressing part are configured different in one of elastic modulus and hardness, the output of the first pressure sensor and the output of the second pressure sensor are configured to indicate different values from each other when the same force acts on the first pressing part and the second pressing part.

4. The force detector according to claim 1, wherein
due to that the first pressure sensor and the second pressure sensor have piezoresistive effects having different characteristics from each other, the output of the first pressure sensor and the output of the second pressure sensor are configured to indicate different values from each other when the same force acts on the first pressing part and the second pressing part.

5. The force detector according to claim 1, wherein
a force detectable range based on the output of the first pressure sensor is configured to overlap a force detectable range based on the output of the second pressure sensor.

6. The force detector according to claim 1, further comprising:
a plurality of the first pressure sensors;
a plurality of the first pressing parts;
a plurality of the second pressure sensors; and
a plurality of the second pressing parts.

7. The force detector according to claim 6, wherein
each of the plurality of the first pressure sensors and each of the plurality of the second pressure sensors are distributedly disposed so as to be alternately adjacent to each other.

8. The force detector according to claim 2, wherein
due to that the first pressing part and the second pressing part are configured different in one of elastic modulus and hardness, the output of the first pressure sensor and the output of the second pressure sensor are configured to indicate different values from each other when the same force acts on the first pressing part and the second pressing part.
